(19) United States
(12) Patent Application Publication
(10) Pub. No.: US 2006/0244954 A1
(43) Pub. Date: Nov. 2, 2006

(54) System and method for inspecting packaging quality of a packaged food product

(76) Inventors: Wayne D.R. Daley, Snellville, GA (US); Colin Usher, Duluth, GA (US); Douglas Britton, Alpharetta, GA (US); Kevin Ruffin, Culloden, GA (US); Daniel Scott Wilburn, Woodruff, SC (US)

Correspondence Address: TROUTMAN SANDERS LLP, 600 PEACHTREE STREET , NE, ATLANTA, GA, 30308, US

(21) Appl. No.: 11/391,800

(22) Filed: Mar. 29, 2006

Related U.S. Application Data
(60) Provisional application No. 60/666,049, filed on Mar. 29, 2005.

(51) Int. Cl. G01N 21/88

(52) U.S. Cl. 356/237.1

(57) ABSTRACT

A method for inspecting the packaging of a packaged product is presented wherein the packaged product includes a tray and a film enwrapping a product carried on the tray forming a packaging. The method includes providing a tray and providing a packaging film material which contains an additive for producing a high contrasting image under non-visible light when compared to the tray. The additive does not affect the spectral properties of the packaging film material in visible light. The tray and transparent film are illuminated with a non-visible light. The contrasting image of the tray and transparent film is viewed for determining the presence and configuration of the packaging. The configuration of the packaging is analyzed based upon a predetermined expected packaging profile and it is determined if the packaging is substantially similar to the predetermined expected packaging profile constituting an acceptable packaging.

### PRIORITY

This application claims priority to provisional patent application having Ser. No. 60/666,049 entitled System For The Inspection of Overwrap Package Tray By Utilizing Modified Wrapping Film filed Mar. 29, 2005. This provisional patent application is incorporated by reference in its entirety.

### TECHNICAL FIELD

The present invention subject matter relates to a system and method for inspecting the completeness of the overwrap packaging and/or seal containing a variety of packaged products which may include food, medical devices and other manufactured products and more particularly to the utilization of non-visible light being utilized for enhancing the contrast between the packaging material which forms a seal around a tray and the ray utilized for carrying an enclosed packaged product so that the completeness of the packaging may be determined based upon the image produced by the contrast exhibiting a packaging with or without structural integrity.

### BACKGROUND ART

In the field of packaged processing, it is important that the packaged item is delivered in the same condition as manufactured. Hence, sealing machines are utilized for placing a layer of thin film around a tray encapsulating a product. In the food industry for example, it is of primary importance that the food produced and packaged maintains its integrity from the producer to the consumer. Extra care is taken to insure that the food processing environment is sterile and meets governmental requirements. Of course one of the key requirements is that the food is sanitarily packaged and is packaged such that the food when delivered to the ultimate consumer is as fresh as originally packaged. In a meat processing facility, typically, in the packaging process, a commercial sealer is utilized for enwrapping a Styrofoam tray which holds the meat with a clear thin film. However, during the packaging process, errors may occur impacting the integrity of the packaging and/or seal. Accordingly, there is a need to insure that the integrity of the packaging and/or seal exists. This ensures that contamination of the product does not occur during the subsequent transport of the product which could result in causing illness to consumers and requiring an expensive recall of the meat.

However, while there is a need for ensuring the integrity of the package and/or seal around the tray, such inspection processes are difficult to maintain due to the nature of the thin film utilized for packaging. Typically the thin film which is utilized for sealing the packages that contain the meat products is made from polyethylene and is transparent so that the consumer can visibly inspect the quality and cut of meat packaged. However, due to the transparent nature, it is extremely difficult to detect any inconsistencies in the packaging and/or seal around the Styrofoam tray as the thin film passes light through to the tray, because of its transparency.

Additionally, another factor for consideration involving the incorporation of certain inspection procedures of the food processing system entails the impact that the inspection have on the overall cost and time of processing. While it is of vital importance to ensure the sanitized delivery of food product to consumers, procedures in place to ensure such a result must also be feasible and economical. Consequently, any advancement of the packaging inspection process must ensure that it does not impede a critical area of the food processing facility; namely either food quality, costs of processing or excessive processing time. Currently the packaging inspection station is one of the most labor-intensive aspects of the entire food production system.

Accordingly it is an object of the present invention to provide a system and method for the inspection of the packaging of food packages;

It is another object of the present invention to provide an economical solution to the seal inspection process.

### SUMMARY

A method for inspecting the packaging of packaged product is presented wherein the packaged product includes a tray and a film enwrapping a product carried on the tray forming a packaging. The method includes providing a tray and providing a packaging film material which contains an additive for producing a high contrasting image under non-visible light when compared to the tray. The additive does not affect the spectral properties of the packaging film material in visible light. The tray and transparent film are illuminated with a non-visible light. The contrasting image of the tray and transparent film is viewed for determining the presence and configuration of the packaging. The configuration of the packaging is analyzed based upon a predetermined expected packaging profile and it is determined if the packaging is substantially similar to the predetermined expected packaging profile constituting an acceptable packaging.

### BRIEF DESCRIPTION OF THE DRAWINGS

The methods and system designed to carry out the invention will hereinafter be described, together with other features thereof.

The invention will be more readily understood from a reading of the following specification and by reference to the accompanying drawings forming a part thereof:

FIG. 1 is a top plan schematic view of the inspection system;

FIG. 2 is a schematic cross-sectional view of the inspection station taken along lines 2-2 in FIG. 1;

FIG. 3 is a schematic cross-sectional view of the inspection station taken along lines 3-3 in FIG. 2;

FIG. 4 is an illustration of the results obtained when the packaging material includes an infra-red absorbent additive;

FIG. 5A is an illustrative example of an expected seal profile based upon the operation of a particular sealer;

FIG. 5B is a worm's eye perspective view of an example of a properly sealed package sealed according to the system shown in FIG. 1;

FIG. 5C is an illustration of a structurally sound seal present on a package sealed according to the system shown in FIG. 1;

FIG. 5D is a perspective view of a package seal as shown in FIG. 5B as viewed through one camera and associated electronics produced by the contrasting system when the packaging film has an additive which is excited by ultraviolet light identifying an integral seal;

FIG. 6A is a worm's eye perspective view of an example of an improperly sealed package as seen in visible light;

FIG. 6B is an illustration of a structurally defective seal present on a package sealed according to the system shown in FIG. 1;

FIG. 6C is a perspective view of a package seal as shown in FIG. 6A as viewed through one camera and associated electronics produced by the contrasting system when the packaging film has an additive which is excited by ultraviolet light identifying a structurally unsound seal; and

FIG. 7 illustrates a perspective schematic view of the inspection cell and associated imaging system.

### DESCRIPTION OF THE PREFERRED EMBODIMENT

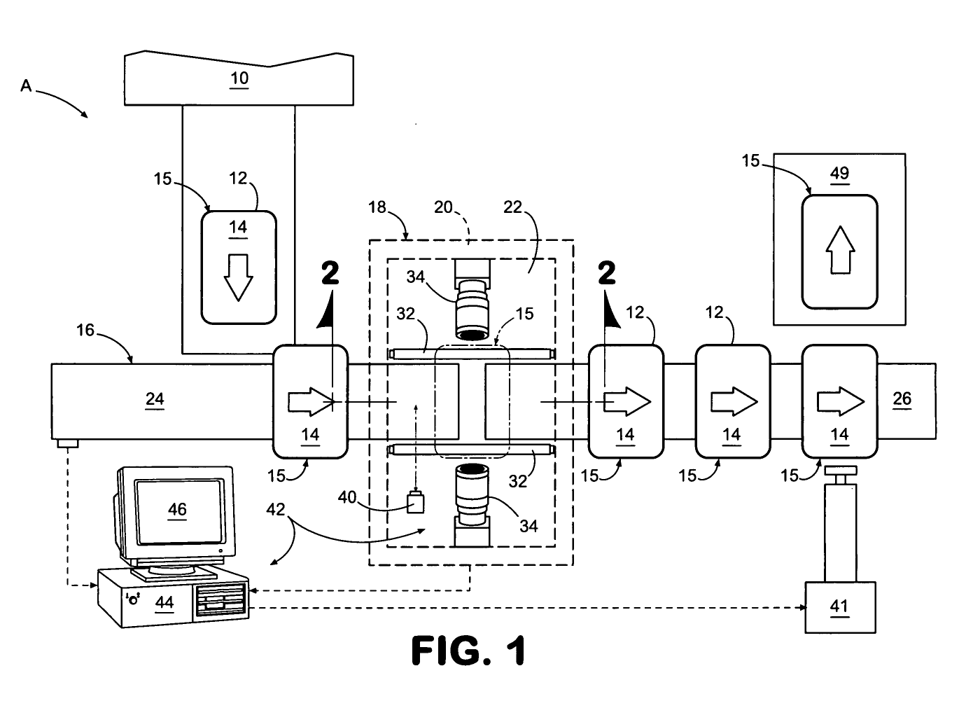

Referring now in more detail to the drawings, the invention will now be described in more detail. As shown in FIG. 1, a product processing system A includes a sealer 10 which enwraps a tray 12 containing a product for packaging which may be meat, a medical device, or the like with a thin transparent membrane 14 to produce a sealed package 15. The sealed package is transported via conveyor belt 16 to inspection station 18. At inspection station 18, the package and/or seal is inspected for structural integrity.

At the inspection station 18, a method exists for inspecting the seal of the packaged product. The method includes providing a substantially enclosed housing 20 having an interior 22. Within the interior the tray and transparent membrane are subject to a non-visible light which results in the production of a high contrast visible image of the tray and transparent film. A critical feature of the present invention is that the transparent film be modified to include an additive which enables the transparent film to produce a contrasting image with the tray.

Typically the tray is made from Styrofoam and the transparent film is polyethylene. The polyethylene film is transparent so that an individual consumer may view the product without any inconsistencies being produced by the film. Consequently, the polyethylene film typically passes through all visible light producing the transparent quality of the film. While this is suitable for a consumer, such transparency makes the detection of flaws within the packaging or seal difficult by the unaided eye. By modifying the polyethylene film to contain a contrasting agent which enables the polyethylene film to produce a highly visible contrasting image with respect to the tray when exposed to non-visible light, a system and method exists for inspecting the packaging and seal which does not ultimately impact the transparent nature of the film. With the transparent nature of the film intact under visible light, the consumer's view of the packaged food product is not impeded from the view presented by standard polyethylene film.

Thus, the invention consists of the production of a high contrast image between the film and the tray utilizing modified film material which will produce a high contrasting image under non-visible light, but which in visible light does not affect the spectral aspects of the film as it relates to the consumer

The contrasting image between the film and tray can be produced utilizing three distinct methods. First, the film could be modified to either absorb light in the non-visible infra-red range above 900 nanometers of wavelength, or the package could be thermally imaged using thermal IR immediately after sealing, or the film could be modified to have an additive which becomes excited when encountering ultraviolet light producing a visible excited image. Thus a key to the invention is the utilization of a contrasting agent which as described herein is a material added to the packaging film such that when the film is exposed to non-visible light, the contrasting agent enables the packaging film to produce a contrasting image when compared to the tray, such that the structural integrity of the packaging and/or seal of the packaging may be determined. Additionally the contrasting agent must not impact the transparent qualities of the film under the visible light spectrum. In the preferred embodiment, a high contrasting image is one wherein the transmission or reflectance percentage of the non-visible light between the package tray and the packaging material is at least greater than ten percent.

As shown in FIG. 1, inspection station 18 includes a first conveyor portion 24 and a second conveyor portion 26. Preferably second conveyor portion 26 is a separate conveyor offset from first conveyor portion 24. The second conveyor portion 26 is offset from first conveyor portion 24 defining a viewing area 28 wherein sealed package 15 may be inspected. Inspection station 18 includes a housing for housing a plurality of lights 32 and cameras 34 for inspecting the integrity of the package and/or seal.

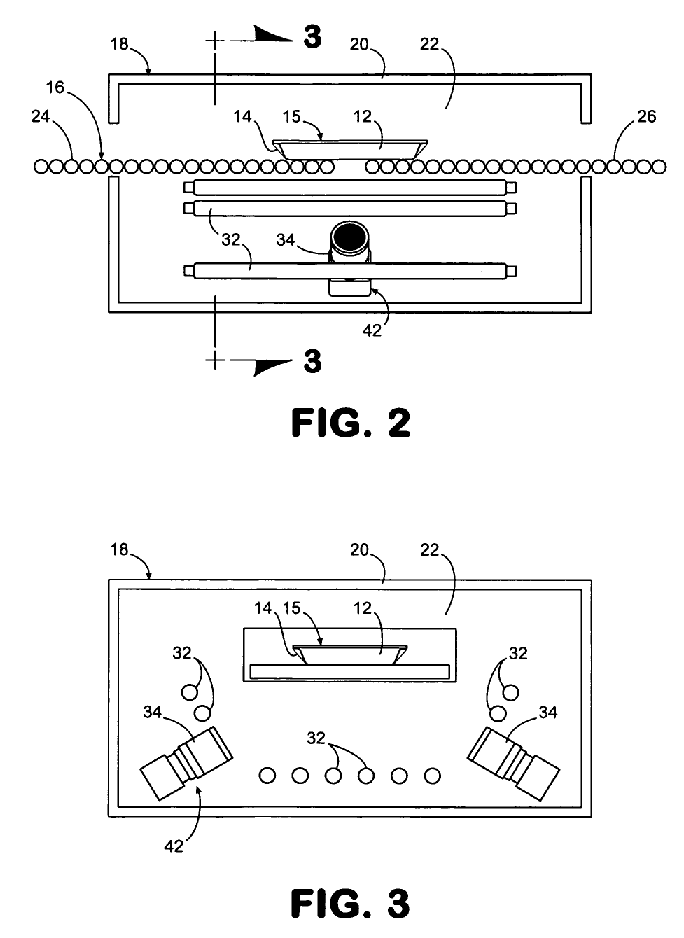

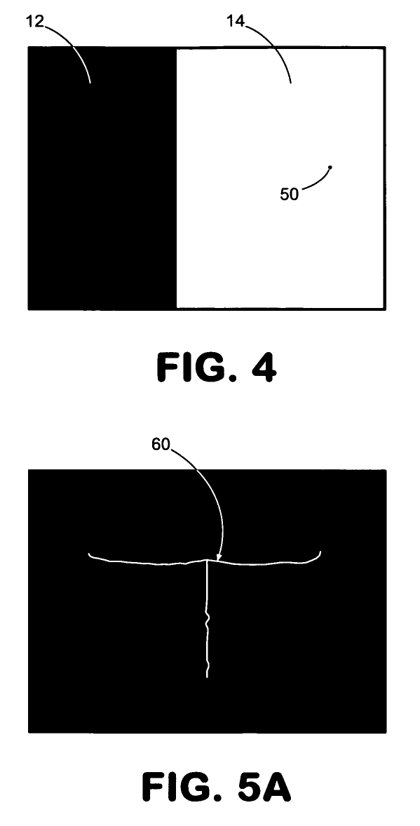

As shown in FIGS. 1, 2 and 3, inspection station 18 incorporates lights 32 and cameras 34 in a manner which enables the packaging and/or seal of package 15 to be inspected. Within inspection station 18, lights 28 emit a non-visible light which produces a contrasting image between the tray and packaging film. Pursuant to one embodiment of the invention, lights 28 emit a light in the non-visible wavelength spectrum which constitutes the infrared spectrum above 900 nanometers wavelength band which is above visible. When utilizing this embodiment of the invention, the packaging film 14 has been enhanced with an additive which would absorb the infra-red light. Such material could be either Lanthanum Hexaboride—LaB6. As shown in FIG. 3, the result is that the film 14 appears a first distinguishable shade, and the uncovered area of tray 12 a second contrasting shade as the tray would reflect the infra-red light while the film would absorb it. In the illustration shown in FIG. 4, a void 50 in the film 14 is illustrated by the presence of the same contrasting shade of tray 12 within the area of film 14. In this embodiment, infra-red sensors are utilized for measuring any reflective energy. If such energy is registered, this identifies that a breach exists within the sealing material as the energy being sensed is being transmitted by the tray and would ordinarily be absorbed by the sealing material.

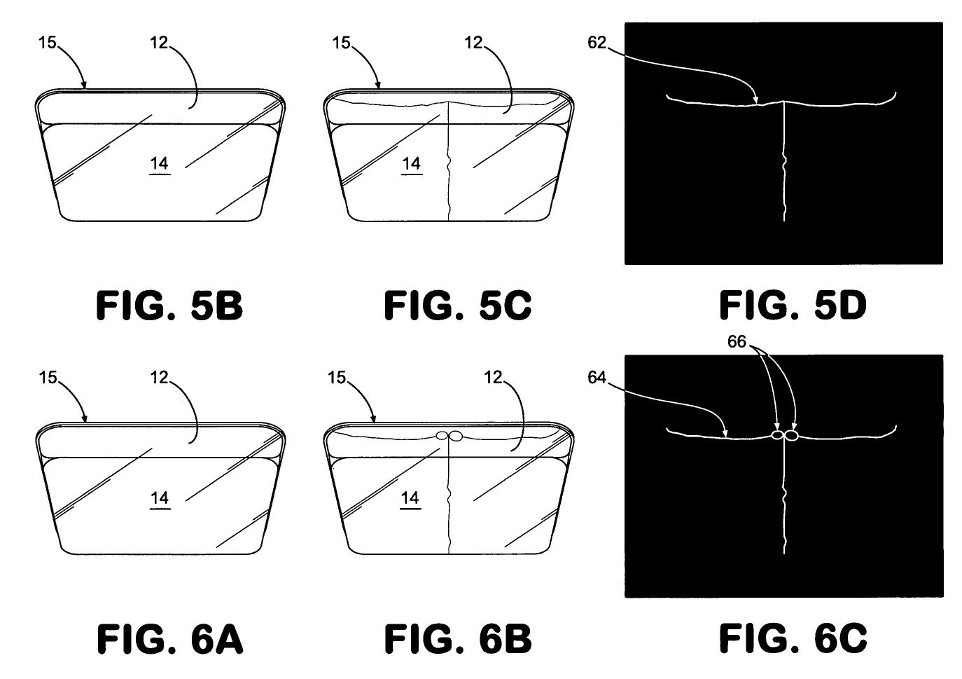

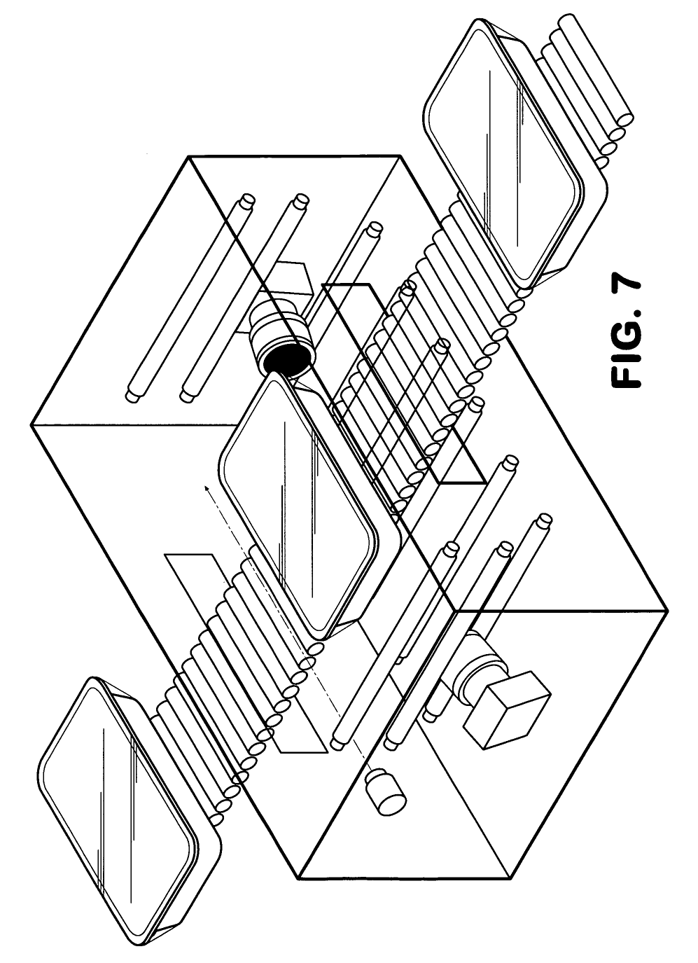

In an embodiment where food is packaged, non-visible light in the ultraviolet spectrum around 265-350 nanometers wavelength band may be utilized. In this embodiment, the packaging film 14 has been enhanced with an additive which produces visible light when excited by the ultraviolet light. This process results in the generating of light at around 450-500 nanometers wavelength which is in the visible spectrum. In these spectral bands, it has been discovered that the wrapping material generates visible light while the tray will not. Examples of this are shown in FIGS. 4 through 5. In this embodiment, it is particularly useful for determining the structural integrity of the seal of the packaging film. By having more material in the seal, the contrast between the seal and tray and the remainder of the packaging film is enhanced and readily apparent with the tray providing a black background for the seal.

In operation, typically a seal is positioned onto a package around the sides and bottoms. This leaves the top of the food product package unscathed for cosmetic appearance purposes enabling the consumer to view the product cleanly. As mentioned, the high contrast is established by providing stimulating energy of non-visible light such that the energy released by the packaging material in general and specifically at the seal is more than the energy released by the tray producing the high contrast visible image. Since the seal includes more transparent material than other areas of the film, the seal is the most visible image produced by the non-visible light. The high contrast image of the tray and transparent film is viewed for determining the presence and configuration of a seal. Then, it is determined if the seal is devoid of structural interruptions.

In the preferred embodiment the packaging film material has been modified to contain a material which will fluoresce under ultraviolet light. This material is provided by Cryovac, Inc. of Duncan, S.C. Distinguishing the Styrofoam tray from the membrane material via the fluorescence in the visible electromagnetic wavebands it lowers the costs of the sensors. Additionally, the fluorescing material is preferred as it is approved for food use at certain concentration, allows for the use of relatively low cost sensors while at the same time not affecting the visible properties of the film under normal conditions. In operation, the membrane is stimulated with UV radiation from the lights and the cameras detect the visible fluorescence with a sensor responsive in the visible electromagnetic wave bands. This is preferably done with black and white cameras to reduce cost. The acquired images are subsequently analyzed to identify defects. The analysis of the seal may be done by presenting the images from the camera to displays for visual inspection by an inspector, or is preferably transmitted from the cameras to a computer for comparison with a control specimen.

In operation as shown in FIGS. 1, 2, and 3 a package is sealed by sealer 10 and conveyed to inspection station 18. Inspection station 18 consists of a housing 20 which is configured to equally distribute the UV light from lights 32. The even distribution of light is important as the ultimate inspection involves contrasting the reflection of the UV by the sealing material from the reflection by the tray. Consequently, irregular fluorescent light generation due to an uneven distribution of light would present a false analysis of the seal as some areas would be less stimulated giving the appearance of a broken seal. Housing 20 encloses package 15 for the inspection process. Housing 20 has a generally integral periphery preventing light from entering into the interior and disrupting the reflection of the non-visible light by the package. In the preferred embodiment, housing ingress and housing egress respectfully consist of a resilient rubber flap located which is typically in a first position blocking the ingress and egress preventing light from entering into the inspection cell, and a second position enabling the sealed package to enter into and exit from the inspection cell interior. The rubber flap will oscillate between these two positions depending on the presence of a sealed package for inspection entering and exiting from the inspection cell interior.

Once inside the inspection cell interior, the lights emit a non-visible light in either the infra-red or ultra-violet spectrum. In the preferred embodiment, a position sensor 40 senses the presence of sealed package within the inspection cell for inspection. Position sensor 40 may be located in the vicinity of the second conveyor portion. When a sealed package is sensed by position sensor, both the first and second conveyor portions are stopped positioning the sealed package over the viewing gap. Additionally, when the sealed package is sensed, cameras 34 are turned on for viewing the bottom and side portions of the sealed package for identifying the contrast between the seal and the Styrofoam tray. Also, this system could operate in real time wherein the packages are continuously presented along the respective conveyors and the images are taken in real time as they packages pass through the viewing area.

In one embodiment, cameras are positioned on both sides of the tray so that a view area approximately one hundred and eighty degrees from the left side of the tray to the right side of the tray and including the bottom can be illuminated by the lights and viewed by the cameras. Also, in the preferred embodiment a camera is utilized to inspect a label which may be positioned on the top surface of the transparent membrane.

When the cameras view the contrast between the Styrofoam tray and transparent membrane, the view is presented to either a person or viewing system for review. In the preferred embodiment, a viewing system 42 is utilized. Viewing system 42 includes a computer 44 which stores a predetermined image of an integral seal for comparison with the images produced by the cameras within the inspection station and a display 46. When the images of the respective cameras are combined to present a full seal view, this image is analyzed based upon a the predetermined configuration of a seal with structural integrity for determining if the seal is structurally sound. If the seal is intact, then it is determined that the package is in condition for further delivery in the processing, if the seal is determined to be broken, then a reject signal is generated and delivered to a rejection system for removing the inspected package from the food processing line and presenting the package for subsequent repackaging. The rerouting of the broken seal package may be done by several types of re-routers 41 including a pivoting arm, a laterally moving bar, a push rod or the like. In all of these circumstances, a signal is received from the computer identifying that the package being inspected requires removal from the processing line for delivery to a rejection station 49 wherein the package is either repackaged or rejected.

Also, the computer 44 is operatively connected to the first and second conveyor portions for determining the positioning of the sealed package with respect to its location with the respective conveyor portions. Numerous ways may be utilized for this including encoders, bar code readers, light beams and the like. The system operates such that the position of a package is determined for inspection within the inspection cell and also for being rerouted to a rejection station if necessary.

FIGS. 5A thorough 5D illustrate the inspection of a good seal. FIG. 5A illustrates the expected seal configuration 60 produced by sealer 10. FIG. 5B illustrates that generally the appearance of a seal with a Styrofoam tray under normal lighting conditions, namely that without undue effort, a seal is not generally visible as the transparent nature of the film does not reflect or absorb the visible light. FIG. 5C schematically illustrates the seal as it is on the package at the time of inspection. FIG. 5D illustrates the seal 62 as it is illuminated in the inspection cell. The contrast between the seal and the tray is realized due to the fact that more film material is congregated in an isolated location at the seal due to the over wrapping of the film material to form the seal, i.e. the thickness of the transparent material may be twice as much at the seal, the visible light produced by the UV excited additive in the packaging film is readily visible compared to the remainder of the packaging material and tray. Additionally, in the case presented, since the tray itself doesn't reflect any of the light, the tray shows up as black. This contrast produces an image of the seal which in FIG. 5D appears T-shaped. This image is analyzed based upon the predetermined seal configuration of FIG. 5A stored at the computer for determining if the seal is complete or not. The seal in FIG. 5D has similar horizontal and vertical profiles as the control seal, and is accordingly deemed a good seal.

FIGS. 6A through 6C illustrate an example of a bad seal. Again, FIG. 6A illustrates the difficulty in visually inspecting a seal. FIG. 6B identifies as an example the presence of a bad seal, however due to the transparent nature of the film material, under visible light, the seal appears as that shown in FIG. 6A. FIG. 6C illustrates the contrast produced by the packaging film material with the UV excited additive and the tray identifying a different seal configuration 64 than the expected seal configuration shown in FIG. 5A. Thus, when the seal in FIG. 6C is analyzed, the oval profiles 66 would be deemed inconsistent with the expected seal design, and it would be determined that the seal's integrity is broken. Accordingly, this package will receive a status of “reject” and a signal will be delivered to the package re-router for rerouting the package to the rejection station.

Thus it may be seen that a more advantageous system and method may be had for inspecting the quality of the package and/or seal for packaged meats. When the infra-red method is utilized, the entire packaging including the seal may be analyzed as hot spots are presented by the infra-red light being reflected by the tray material indicating a break in the packaging material either along the seal or within the primary body of the packaging material. In this instance the term “packaging” implies the entire film material. When the ultra-violet method is utilized, this method is especially conducive to inspecting the quality of the seal as the contrasting image is most pronounced by the enhanced exciting visible image produced by the more dense material formed at the seal.

By utilizing a packaging film which has been modified to include an additive which reacts under non-visible light in a different manner than the packaging tray, a contrast between the packaging film and tray may be observed for identifying the package and/or seal integrity. However, by ensuring that the additive does not affect the visual spectral qualities of the film, the consumer's experience in visually inspecting the food product is not impaired. In this specification reference to visible and non-visible light refers to electromagnetic waves which have wavelengths in the visible spectrum and non-visible spectrum.

The packaged meat tray is presented to an inspection cell wherein a light which is preferred to be in the non-visible range is utilized for contrasting the packaging film with the tray. This light is produced by a plurality of lights which are operated in conjunction with the configuration of the interior of the inspection cell to produce a consistent brightness of light throughout the interior of the inspection cell. Since the seal consists of the thickest part of the transparent packaging film, the seal becomes visible due to its contrasting nature with the tray and the remainder of the sealing material. Cameras record the contrasting image, either continuously or as a still photo and present this information for review. The seal image is analyzed with respect to a predetermined image of a structurally sound seal. If the seal resembles the structurally sound seal, then the seal is good, if a match does not exist, then the seal is determined to be bad and a rejection signal is sent to a package re-router for removing the package from the food processing line and delivering the defective package to a rejection station. Also if desired, an additional camera may be utilized for inspecting the positioning of a label on the package. As with the seal, the image of the label is recorded by a camera and sent to a computer for comparison with a control image. As with the seal, a determination is made regarding the quality of the package based upon a control image.

This system automates a process which is currently very labor intensive. In doing so, a more economical process may be had, both regarding the cost to inspect and time to inspect and a more thorough inspection process may be had than currently undertaken when compared to the manual approach via normal lighting conditions. This system solves a long-felt need in the food processing industry. In addition

We claim:

1. A system for inspecting the overwrap packaging of a packaged product which includes a tray carrying a product enwrapped by a transparent packaging material, said system comprising:
a package support;
a light source for emitting non-visible light upon the tray and transparent packaging material;
a camera for viewing the contrast produced between the tray and transparent packaging material when subjected to the non-visible light for providing an image representative of the subject packaging;
a computer having an image of a packaging having structural integrity; and
said computer having instructions for analyzing the image of packaging having structural integrity with the image representative of the subject packaging for determining the quality of the packaging.

2. The system of claim 1 further including a housing having an interior and wherein said light source and camera are housed within said interior.

3. The system of claim 2 wherein the package support includes a first conveyor portion and a second conveyor portion offset from the first conveyor portion defining a viewing gap, said camera disposed for viewing said packaging within said viewing gap.

4. The system of claim 2 including a plurality of lights within said housing interior, said plurality of lights emit a consistent intensity of light throughout said housing interior.

5. The system of claim 1 further including a camera for viewing a top portion of said package for determining the positioning of a label.

6. The system of claim 5 wherein said computer also includes instructions for comparing the image of the label with a control image of a correctly placed label for determining the quality of the positioning of the label.

7. The system of claim 1 wherein said transparent material includes an additive material which is excited to produce a visible light when exposed to a non-visible light within the ultraviolet spectral banding for contrasting the seal with the tray.

8. The system of claim 1 further including a re-router for positioning the package at a predetermined location if the packaging quality is determined to be unacceptable by being different than the predetermined packaging image, said predetermined location being different than if the subject packaging image is determined to be substantially similar to said control image.

9. A method for inspecting the overwrap packaging of a packaged product, said method comprising:
providing a tray;
providing a packaging film material which contains an additive for producing a high contrasting image under non-visible light when compared to said tray; said additive not affecting the spectral properties of the packaging film material in visible light;
illuminating the tray and transparent film with a non-visible light;
viewing the contrasting image of the tray and transparent film for determining the presence and configuration of the packaging;
analyzing the configuration of the packaging based upon a predetermined expected packaging profile; and
determining if the packaging is substantially similar to said predetermined expected packaging profile constituting an acceptable packaging.

10. The method of claim 9 further including the step of positioning said a packaged product at a predetermined area if said packaging is determined not to be substantially similar to the expected packaging profile, said predetermined area being different from the area where packages having acceptable packaging are delivered.

11. The method of claim 9 including providing a housing having a substantially enclosed interior devoid of exterior light, said illumination occurring within said housing interior utilizing light sources which emit non-visible light.

12. The method of claim 11 wherein said light sources emit non-visible light in the ultra-violet spectral wavebands.

13. The method of claim 9 including cameras for recording the image of the tray and packaging, said cameras communicating the image to a display for review.

14. The method of claim 9 including cameras for recording the image of the tray and packaging material, said cameras communicating the image to a computer for comparing the image to said control image.

15. The method of claim 9 further including the step of viewing the positioning of a label located on the top surface of the package and determining if such positioning is acceptable.

16. A method for inspecting the seal of a packaged food product wherein the packaged food product includes a tray and a transparent film enwrapping the tray and wherein the film forms a seal, said method comprising:
providing a substantially enclosed housing having an interior;
illuminating the tray and transparent film within said housing interior with a non-visible light for producing a contrasting image of the tray and transparent film;
viewing the contrasting image of the tray and transparent film for determining the presence and configuration of a seal; and
determining if the seal is devoid of structural interruptions.

17. The method of claim 16 including utilizing cameras for recording the viewing of the contrasting image and presenting the image for analysis.

18. The method of claim 17 wherein contrasting image is presented by said cameras to a computer for comparing the seal with a control specimen and determining the integrity of the seal.
